(19) United States
(12) Patent Application Publication
(10) Pub. No.: US 2015/0093299 A1
(43) Pub. Date: Apr. 2, 2015

(54) MOF Clean Exhaust System

(71) Applicant: Kurt Keith Schnaars, Ridgewood, NJ (US)

(72) Inventor: Kurt Keith Schnaars, Ridgewood, NJ (US)

(21) Appl. No.: 14/043,813

(22) Filed: Oct. 1, 2013

(51) Int. Cl. B01D 53/02; B01J 20/22

(52) U.S. Cl. CPC B01D 53/02; B01J 20/226; B01D 2253/204
USPC 422/177

(57) ABSTRACT

The MOF Clean Exhaust System has three components: the exhaust system, the crystal encasement, a CO₂ filter, and the MOF Crystals. These components rely on one another to complete the task of effectively minimizing emissions, and decreasing the output of CO2 from the vehicle's exhaust system. While the car is running, the exhaust will flow through the exhaust system, the CO₂ filter and into the MOF tank. The tank is vacuum-sealed; therefore, the crystals will be able to work to their fullest capacity in absorbing CO2. From this sealed compartment the user will be able to connect a hose at the extraction point from the tank. Here there is a switch to open the tank and release the CO2. This released CO2 will be collected in underground tanks, and can then be recycled for use in compressed air tanks for construction equipment, or even for the production of synthetic fuels.

Metal-Organic Frameworks are crystalline compounds consisting of metal ions or clusters coordinated to often rigid organic molecules to form one-, two-, or three-dimensional structures that can be porous, in some cases, the pores are stable-enough for the elimination of the guest molecules, (often solvents) and can be used for the storage of gases such as hydrogen and carbon dioxide. Other possible applications of MOFs are in gas purification, in gas separation, in catalysis and as sensors.
Wikipedia contributors. “Metal-organic framework.” Wikipedia, The Free Encyclopedia. Wikipedia, The Free Encyclopedia, 18 Oct. 2011. Web. 28 Dec. 2011.

### MOF Storage Methods:

| MOF Storage Methods | Pm | Pv | T | P |
|---|---|---|---|---|
| Storage Methods | (Mass %) | (kgH2/m\hat{ }3) | (Deg. C.) | (Bar) |
| High-pressure gas cylinders | 13 | <40 | 25 | 800 |
| Liquid Hydrogen in | size- | 70.8 | −252 | 1 |
| cryogenic tanks | dependent | | | |
| Absorbed Hydrogen | ~2 | 20 | −80 | 100 |
| Adsorbed on intersitial | ~2 | 150 | 25 | 1 |
| sites in a host metal | | | | |
| Complex Compounds | <18 | 150 | >100 | 1 |
| Metal and complexes | <40 | >150 | 25 | 1 |
| together with water | | | | |

Of these, high-pressure gas cylinders and liquid hydrogen in cryogenic tanks are the least practical ways to store hydrogen for the purpose of fuel due to the extremely high pressure required for storing hydrogen gas or the extremely low pressure required for storing hydrogen liquid. The other methods indicated within the chart above are all being studied extensively.

### MOF Structural Defects:

Structural defects also play an important role in the performance of MOFs. Room-temperature hydrogen uptake through bridged spillover is mainly governed by structural defects, which may have two effects:
1) A partially collapsed framework can block access to pores; thereby reducing hydrogen uptake, and
2) Lattice defects can create an intricate array of new pores and channels causing increased hydrogen uptake.

Structural defects can also leave metal-containing nodes Incompletely coordinated. This enhances the performance of MOFs used for gaseous storage by increasing the number of accessible metal centers. Finally, structural defects can affect the transport of phonons, this affects the thermal conductivity of the MOF

### MOF Pore Size:

In a microporous material where physisopsorption and weak van der Waals forces dominate adsorption, the storage density is greatly dependent on the size of the pores. Calculations of other materials, such as graphitic carbons and carbon nanotubes, predict that a microporous material with 7 Å-wide pores will exhibit maximum gaseous uptake at room temperature. At this width exactly two layers of molecules adsorb on opposing surfaces with no space left in between

### Works Cited:

1. “Metal-Organic Frameworks for Hydrogen Storage . . . and CO2 Capture.” Green Car Congress, Ed. Mike Millikin. 2 Dec. 2005. Web. 21 Nov. 7011. <http://www.greencarcongress.com/2005/12/metalorganic_fr.html>.
   Principal Investigator's Names: Omar M. Yaghi, Tamer Yildirim,
   Institution where research is being conducted:
      Yaghi's team is located at UCLA.
      Tuner Yildirim's team is located at the National Institute of Standards and Technology (NIST).
2. Chen, Banglin. “UTSA Department of Chemistry.” Welcome to The University of Texas at Sun Antonio|UTSA. Department of Chemistry. Web. 21 Nov. 2011. <http://utsa.edu/chem/chen.html>.
   Principal Investigator: Banglin Chen
   Institution where research is being conducted:
      The University of Texas at San Antonio, College of Sciences
3. “High-Throughput Discovery of Robust Metal-Organic Frameworks for CO2 Capture” Web. 21 Nov. 2011. <http://arpa-e.energy.gov/LinkClick.aspx?fileticket=2QiZRhU2kEo%3D&tabid=378>.
   Principal Investigators: Kenji Sumida, Tae-Hyun Bae, Sean Kong, Maciej Haranczyk, Abhoyjit S. Bhown, Eric R. Masanet, Steen S. Kaye, Jeffrey A. Reimer, Berend Smit, and Jeffrey R. Long
   institution where research is being conducted:
      Berkeley National Laboratory, CA

### MOE Sensitivity to Air:

MOFs are frequently air/moisture-sensitive. In particular, IRMOF-1 degrades in the presence of small amounts of water at room temperature. Studies on metal analogues have unraveled the ability of metals different than Zn to stand higher water concentrations at high temperatures.

To compensate for this, specially constructed storage containers are required, which can be costly. Strong metal-ligand bonds, such as in metal-imidazolate, -triazolate, and -pyrazolate framework, are known to decrease a MOF's sensitivity to air, reducing the expanse of storage.

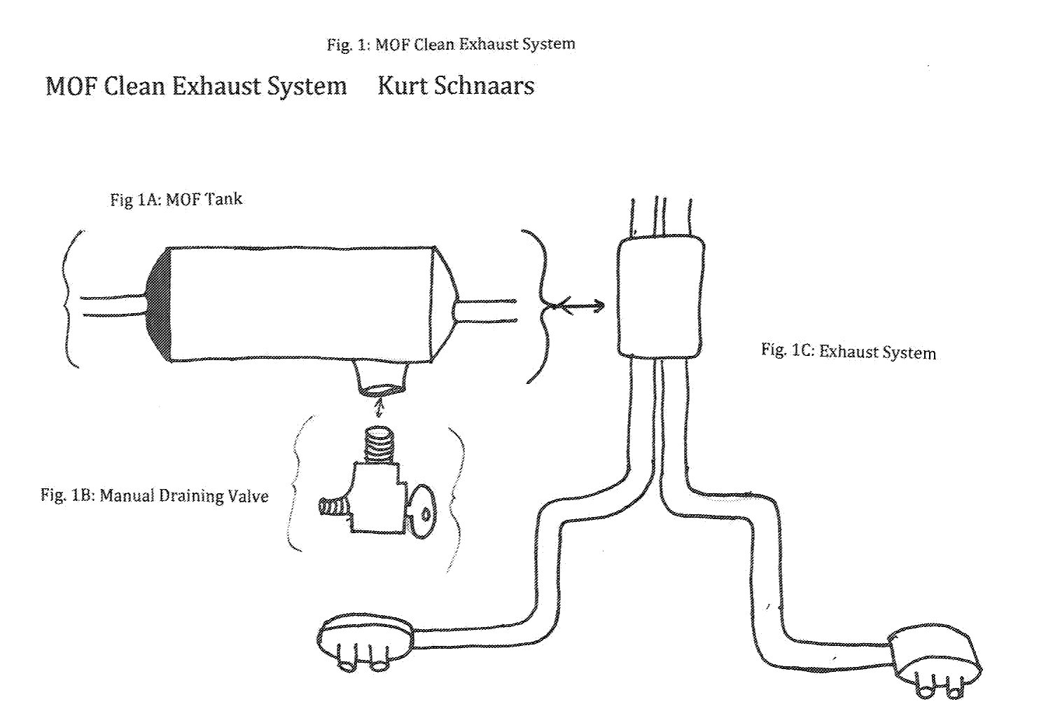

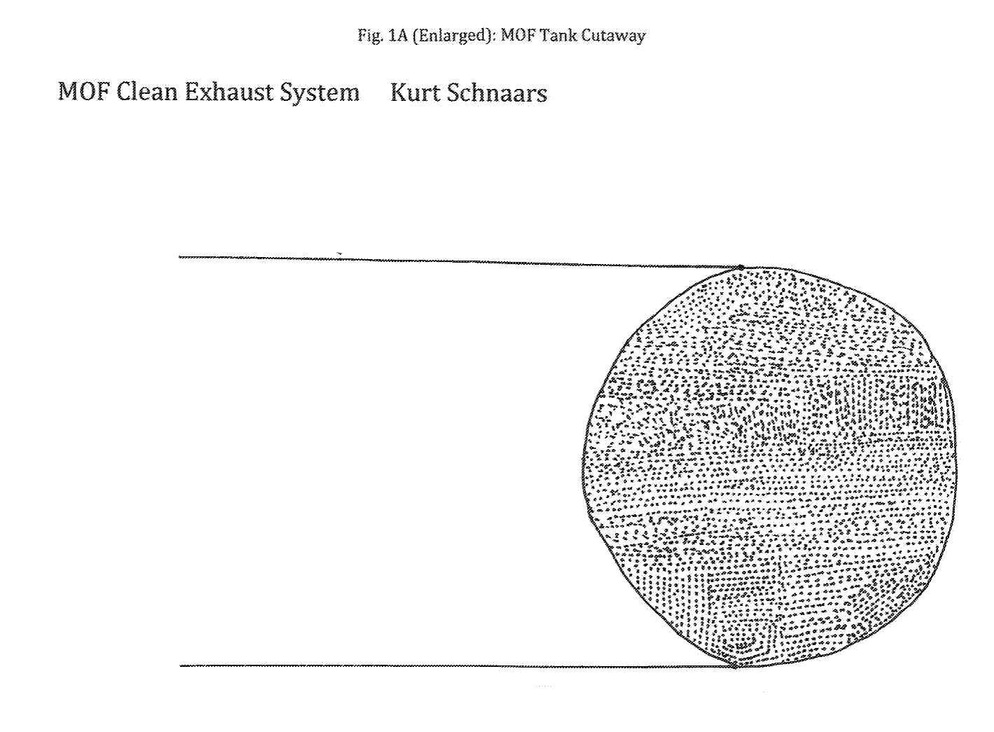

### CUTAWAY DRAWING FIG. 1A (ENLARGED)

The depiction of FIG. 1A (Enlarged) is a cutaway drawing of the MOF tank itself, The tank is first filled with the MOF material. The tank is then made airtight using multiple weld-lines. From here, the tank is ready to be implanted into the car's exhaust system. The tank will be inserted at the factory at the time of manufacture of the automobile so that the user will not have to worry about implanting the tank, or buying the MOF material itself.

### DESCRIPTION OF EXHAUST FLOW THROUGH MOF CLEAN EXHAUST SYSTEM

Exhaust will be able to flow through the MOF Clean Exhaust system (FIG. 1A, FIG. 1C) as smoothly as it flows through the current standard exhaust system, However, as the exhaust flows through the MOF tank (FIG. 1A), the CO2 will be trapped, and then held within the airtight compartment.

### Logo Description for Automobile Manufacturers:

In association with my product, there will be a logo put in place on each and every automobile with the MOF clean Exhaust system. Every car will have at least one badge that enables consumers to recognize that the specific automobile they are purchasing has been fitted with the MOF Clean Exhaust system.

### Emptying and Re-use of the MOF Material:

The MOF crystals are quite easy to be re-cycled, and as a “green” way of eliminating CO2 emissions from cars, the MOF clean exhaust system (FIG. 1C) can be used as not only a reusable catalyst for CO2 storage, but also a sustainable way to capture and re-direct CO2. This is due the fact that the MOF material has a very long life because it never expires, and does not deteriorate after years of usage.

1. The MOF Clean Exhaust System is a means for trapping carbon dioxide from automobile exhaust This will reduce carbon emissions from gasoline-powered vehicles, The MOF Clean Exhaust System will make our transition into a carbon neutral automobile world painless and less difficult than trying to persuade everyone to drive totally electric cars. By using the MOF Clean Exhaust System, automobile users will not have to worry about emitting harmful carbon dioxide into the atmosphere, while their automobiles consume gasoline. This will make for a more seamless transition into carbon neutral or gasoline free vehicles in the future. We can not just force people to change theft old habits of using gasoline powered vehicles over night, we can, however encourage people to buy “green” vehicles that use the MOF Clean Exhaust System.
